(19) United States
(12) Patent Application Publication
(10) Pub. No.: US 2006/0104061 A1
(43) Pub. Date: May 18, 2006

(54) Display with planar light source

(76) Inventors: Scott Lerner, Corvallis, OR (US); Anurag Gupta, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/991,035

(22) Filed: Nov. 16, 2004

(51) Int. Cl. F21V 21/00

(52) U.S. Cl. 362/249

(57) ABSTRACT

An emitter having a planar light source with a concentrator formed adjacent thereto is herein disclosed.

### BACKGROUND

Planar light sources are commonly used as non-directed light sources. However, a significant amount of light is emitted from these types of sources at angles outside the acceptance cone of typical lenses for projection and monitor systems. As a result, much of the light emitted by planar light sources is unusable. Accordingly, planar light sources are not used as a direct light source for such displays and monitors.

### BRIEF DESCRIPTION OF THE DRAWINGS

FIG. 1 is a schematic side view of one embodiment of an emitter according to an example embodiment of the present invention;

FIG. 2 is a schematic side view of another embodiment of an emitter according to an example embodiment of the present invention;

FIG. 3 is a top schematic view of a rectilinear embodiment of an emitter according to an example embodiment of the present invention;

FIG. 4 is a top schematic view of a curvilinear embodiment of an emitter according to an example embodiment of the present invention;

FIG. 5 is a top schematic view of an array of emitters according to an example embodiment of the present invention; and,

FIG. 6 is a side schematic view of another example embodiment of an array of emitters constructed and arranged to output color images.

### DETAILED DESCRIPTION

In the following detailed description of certain example embodiments of the invention, reference is made to the accompanying drawings that form a part hereof and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

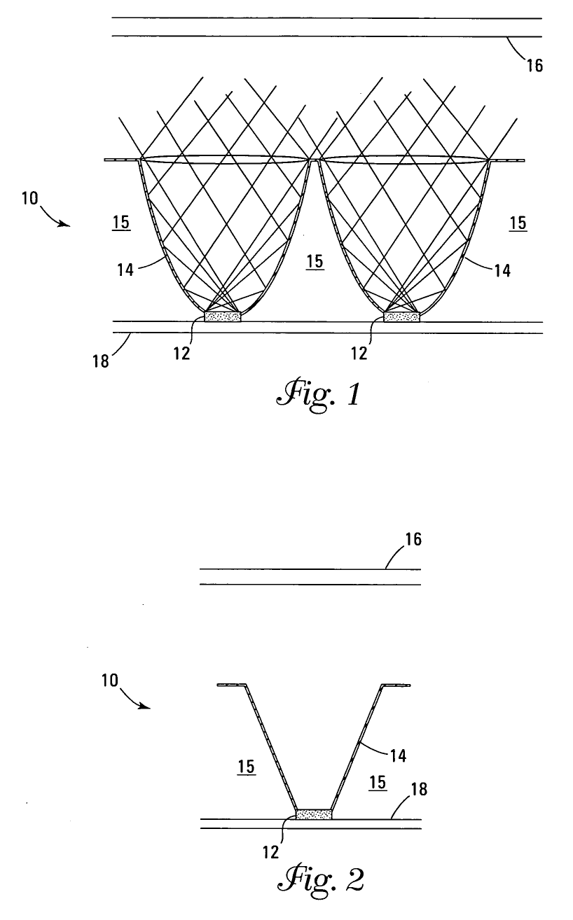

FIG. 1 illustrates one embodiment of a portion of an emitter 10 that may be used to form a display or monitor. The emitter 10 incorporates a plurality of planar light sources 12, each having a concentrator 14 associated therewith that, by means of internal reflection, concentrates and directs light from the light sources 12 onto a lens or magnifier 16. The planar light sources 12 are mounted or disposed on a substrate 18 as is the layer 15 in which the concentrators 14 are formed. Note that the layer 15 in one embodiment is reflective of light output by the planar light sources 12. In other embodiments, the layer 15 may be at least somewhat transmissive of light output by the planar light source 12. Where the layer 15 is transmissive of light output by the planar light sources 12, the interior surface of the concentrator 14 may be provided with a reflective coating. The reflective coating may be applied using known coating techniques, such as, for example, sputtering.

As used herein, the term “planar light source” refers generally to non-directional light sources having a generally planar aspect. In one embodiment, a planar light source 12 is formed on a planar substrate, thereby giving the light source a planar shape. In another embodiment, the planar light source 12 may be formed on a flexible substrate that may or may not have a planar shape. In yet another embodiment, a planar light source 12 may include a plurality of individual non-planar light sources arranged in a generally planar array.

Planar light sources 12, according to some embodiments, generally emit light over half a unit sphere having a solid angle of approximately 2n (˜6.25 steradians). As typical lenses 16 often have an acceptance cone of light of about 24°, much of the light emitted by a typical planar light source 12 without a concentrator 14 is emitted outside the acceptance cone of light of the lens 16 and is therefore lost, as it is not transmitted through the lens 16. Light that is incident upon a lens 16 within Using a concentrator 14 conserves much of the useful etendue of the planar light source 12 and ensures that much of or substantially all of the light emitted by the light source 12 is incident upon the lens 16 within the lens's acceptance cone of light. As a result, planar light sources 12 may be used in a display or monitor to define individual pixels.

Emitters 10 may also find use in directing light from planar light sources 12 onto optical devices other than lenses 16. In alternate embodiments, the lens 16 may be replaced with polarizing filters, diffraction gratings, liquid crystal displays (LCDs), reflectors, and other optical devices. In one embodiment, emitters 10 may be used alone or in conjunction with one or more of the aforementioned optical devices to form a simple light source for basic illumination or for backlighting signage or a display.

Each light source 12 may be defined by one or more light emitting devices such as an organic light emitting diode (OLED), a photonic crystal, or other suitable device. Accordingly, in one embodiment, multiple light emitting devices may be deposited, formed, or otherwise disposed on the substrate 18 to constitute a single light source 12. In some embodiments, photonic crystals can be fabricated in the nanometer dimensions. In another embodiment, a single light-emitting device is formed, deposited, or otherwise disposed on substrate 18 to constitute a single light source 12. The light source 12 may be square as shown in the Figures, but may also take any useful shape, including, but not limited to circular, trapezoidal, and irregular shapes. Circuitry (not shown) for modulating the light sources 12 may be formed as part of the substrate 18, may be deposited on the surface of the substrate 18, or may rest on the surface of the substrate 18, depending on the nature of the light source 12 and the power usage thereof.

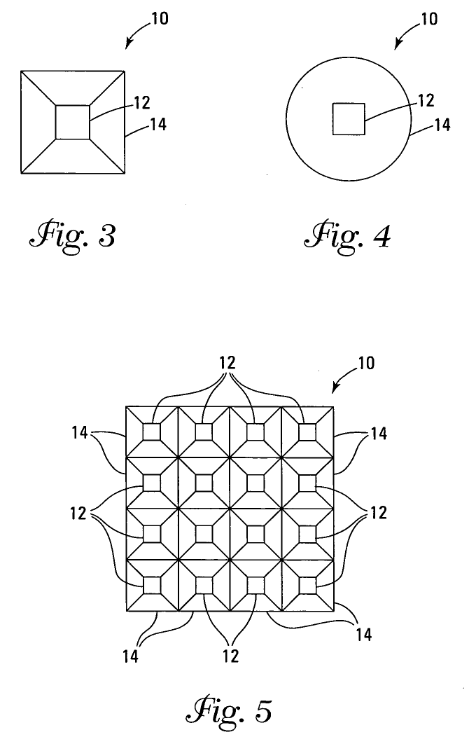

Concentrators 14 may comprise a tapered light pipe and are formed over each of the light sources 12 to receive and concentrate light emitted from the light sources 12. The concentrators 12 generally open up from their bottom end adjacent the light sources 12 to their open end. Note that in some embodiments the open end of concentrators 14 is larger than the bottom end of the concentrators. In one embodiment, the concentrators 14 form a compound parabolic concentrator as illustrated in FIG. 1. In another embodiment, the concentrator 14 may be conical as shown in FIGS. 2 and 4 or pyramidal as illustrated in FIGS. 2, 3, and 5. Other shapes, sizes, and geometries that will concentrate light emitted from the light sources 12 may also be used. Some examples of suitable shapes for the concentrators 14 may include conical, pyramidal, tetrahedral, tapered prisms, parabolic, compound parabolic, and spherical zones.

In some embodiments, the concentrator is arranged such that light emitted from the concentrator 14 has a solid angle with respect to the lens 16 that is substantially 2n (˜6.25 steradians). In this manner, the etendue of the light source 12 is substantially conserved, thereby resulting in more lumens being passed through the lens 16 and a correspondingly brighter display, i.e. light from the emitter 10 is incident upon the lens or other optical device 16 substantially within the cone of acceptance of the optical device. In one embodiment, substantially all of the light from the emitter 10 is incident upon a lens 16 at an angle between about 74° and 90° as measured from the plane of the lens 16.

One or more emitters 10 may be used to define pixels from which an image is formed. For example, FIG. 5 illustrates a 4×4 array of emitters 10. In one embodiment, each one of the emitters 10 may define a single pixel. In another embodiment, and depending on the size of the light source/concentrator combinations, the entire 4×4 array of emitters 10 may define a single pixel. Note, however, that any suitable number and arrangement of emitters 10 may define a single pixel.

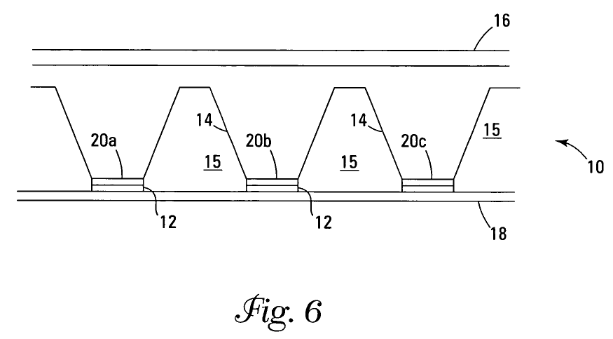

Displays that incorporate emitters 10 may generate grayscale or color images. Where an emitter is arranged to output grayscale images, the emitter(s) 10 that define a single pixel will operate in an on/off manner based upon signals received from an electronic controller (not shown) that provides electrical signals to the light sources 12. An embodiment that is arranged to output color images is illustrated in FIG. 6. In this embodiment, the light sources 12 of the emitters 10 are provided with a colored filter 20 that define what color light is output by the emitter 10. In one embodiment, filter 20a is red, filter 20b is blue, and filter 20c is green. In this embodiment, the three emitters 10 illustrated in FIG. 6 define a single color pixel. Activating the light sources 12 associated with the color filters 20a-20c causes colored light to be emitted from the respective concentrators 14. In this manner, colored images may be output by the display 10. In another embodiment, the light sources 12 of the display 10 may be formed of a material that selectively outputs light at a given wavelength. By way of example, photonic crystals capable of emitting light in the desired wavelengths may be used to form color pixels.

In one embodiment, emitters 10 are constructed using techniques commonly used in the fabrication of semiconductors. For example, light sources 12, in this example being an OLED or a photonic crystal, may be formed on the substrate 18 using semiconductor fabrication techniques. Note that in some instances, the substrate 18 may be rigid or may be to some degree flexible. Conductors (not shown) may be deposited onto the substrate 18 or formed therein using common material deposition and/or doping techniques. Next, a layer of material 15 is deposited upon the substrate 18 over the light sources 12. Concentrators 14 may be formed in this layer 15 as the layer 15 is deposited using a progression of photo etch masks, or may be formed into the layer 15 in a single operation using a suitable etching or ablation process. The material of which layer 15 is made may be reflective with respect to the light emitted from the light source 12, however, in some embodiments it may be desirable to use a material for layer 15 that is somewhat transmissive with respect to the light output from light source 12. In some embodiments, a reflective coating may be applied to the interior of the concentrators 14 as by sputtering or other suitable process. In yet another embodiment, the concentrators 14 may be molded or formed in a separate layer 15 and later applied to the substrate 18 such that the concentrators 14 are operatively aligned with the light sources 12.

Emitters 10 and the conductors (not shown) to operate them may be fabricated in large sheets (not shown) that may be used to form a computer monitor or other display. Alternatively, the emitters 10 may be formed into smaller sheets or pieces and may be used in smaller displays or monitors in items such as personal digital assistants (PDAs), watches, calculators, and other devices.

### CONCLUSION

Although specific embodiments have been illustrated and described herein, it is manifestly intended that this invention be limited only by the following claims and equivalents thereof.

What is claimed is:

1. An emitter comprising:
a substrate;
a planar light source deposited on the substrate; and,
a concentrator having an inner wall and an upper opening and a lower opening, the concentrator being positioned upon the substrate such that the lower opening of the concentrator may receive light emitted from the planar light source.

2. The emitter of claim 1 wherein the upper opening of the concentrator is positioned adjacent an optical device and wherein the inner wall of the concentrator is arranged to direct substantially all of the light emitted from the planar light source onto the optical device.

3. The emitter of claim 1 wherein a plurality of emitters are formed on the substrate to form one of a display and a light source.

4. The emitter of claim 1 wherein the planar light source is a semiconductor device.

5. The emitter of claim 1 wherein the planar light source is one of an organic light emitting diode and a photonic crystal.

6. The emitter of claim 1 wherein the lower opening of the concentrator is smaller than the upper opening thereof.

7. The emitter of claim 6 wherein the inner wall of the concentrator has a shape chosen from a group consisting of conical, pyramidal, tetrahedral, tapered prismatic, parabolic, compound parabolic and spherical zones.

8. The emitter of claim 2 wherein the optical device is chosen from a group consisting of a polarizing filter, a diffraction grating, a liquid crystal display, a lens and a reflector.

9. The emitter of claim 2 wherein substantially all of the light emitted from the concentrator is incident upon the optical device at an angle between about 75° and 90°.

10. The emitter of claim 1 wherein the planar light source comprises a plurality of light emitting devices.

11. The emitter of claim 10 wherein the light emitting devices are one of an organic light emitting diode and a photonic crystal.

12. The emitter of claim 1 wherein a plurality of emitters forms a single pixel.

13. The emitter of claim 3 wherein each emitter forms a single grayscale pixel.

14. The emitter of claim 1 further comprising a color filter disposed adjacent the planar light source.

15. The emitter of claim 14 wherein a plurality of emitters having colored filters forms a single color pixel.

16. A device comprising:
a planar light source;
and a concentrator, the concentrator being positioned adjacent the planar light source.

17. The device of claim 16 wherein the planar light source and its associated concentrator are disposed on a substrate.

18. The device of claim 16 wherein the concentrator is arranged to concentrate and emit light received form the planar light source.

19. The device of claim 16 wherein the concentrator further comprises a reflective inner surface.

20. The device of claim 16 wherein the planar light source comprises one or more light emitting devices.

21. The device of claim 20 wherein the light emitting devices are chosen from a group consisting of an organic light emitting diode and a photonic crystal.

22. The device of claim 16 wherein substantially all of the light emitted from the concentrator is incident upon a lens.

23. The device of claim 16 wherein substantially all of the light emitted from the concentrator is incident upon a lens at an angle between about 75° and 90° as measured from the plane of the lens.

24. The device of claim 16 wherein the planar light source defines a pixel.

25. The device of claim 16 wherein an array of planar light sources defines a pixel.

26. The device of claim 24 wherein a plurality of the pixels output an image in grayscale.

27. The device of claim 24 wherein a plurality of the pixels output an image in color.

28. The device of claim 16 wherein the concentrator comprises an inner wall having an upper opening and a lower opening, the lower opening of the concentrator being positioned adjacent the planar light source, the lower opening being smaller than the upper opening of the concentrator.

29. The device of claim 28 wherein the inner wall of the concentrator has a shape chosen from a group consisting of conical, pyramidal, tetrahedral, tapered prismatic, parabolic, compound parabolic, and spherical zones.

30. A method of making a device comprising:
depositing on a substrate a planar light-emitting device; and,
forming a concentrator adjacent the light-emitting device.

31. The method of making a device of claim 30 further comprising positioning the substrate adjacent an optical device such that substantially all of the light emitted from the upper opening of the concentrator is incident upon the optical device of the monitor.

32. The method of making a device of claim 31 wherein the substrate is positioned such that the light emitted from the concentrator is incident upon the optical device at an angle of between about 74° and 90° from the plane of the optical device.

33. The method of making a device of claim 30 further comprising forming the concentrator with a lower opening positioned to receive light emitted by the planar light-emitting device, an interior wall arranged to concentrate the light received from the light emitting device, and an upper opening for emitting the light from the light-emitting device.

34. The method of making a device of claim 30 further comprising applying a reflective coating to an interior surface of the concentrator.

35. The method of making a device of claim 30 wherein the substrate comprises multiple planar light emitting devices.

36. The method of making a device of claim 30 wherein the planar light-emitting device is selected from a group consisting of an organic light emitting diode and a photonic crystal.

37. The method of making a device of claim 30 wherein the planar light emitting device and the concentrator together define an emitter.

38. The method of making a device of claim 37 further comprising forming an emitter to define a pixel.

39. The method of making a device of claim 37 further comprising forming a plurality of emitters to define a pixel.

40. The method of making a device of claim 30 comprising forming a color filter over the planar light emitting device.

41. The method of making a device of claim 30 comprising forming an inner wall of the concentrator in a shape chosen from a group consisting of conical, pyramidal, tetrahedral, tapered prismatic, parabolic, compound parabolic and spherical zones.

42. An emitter comprising:
a planar light source, and;
a means for collecting and emitting light from the planar light source.

43. The emitter of claim 42 wherein the means has a lower opening positioned adjacent the planar light source and an upper opening positioned adjacent an optical device.

44. The emitter of claim 42 wherein the means comprises an interior surface having a shape chosen from a group consisting of conical, pyramidal, tetrahedral, tapered prismatic, parabolic, compound parabolic and a spherical zone.

45. The emitter of claim 42 wherein the light emitted from the means is incident upon an optical device at an angle between about 74° and 90° from the plane of the optical device.

46. The emitter of claim 45 wherein the optical device is chosen from a group consisting of a lens, polarizing filters, diffraction gratings, liquid crystal displays, reflectors.
